(19) United States
(12) Patent Application Publication
(10) Pub. No.: US 2014/0256835 A1
(43) Pub. Date: Sep. 11, 2014

(54) Polyetherimide/ poly(biphenyl ether sulfone) foam materials

(71) Applicant: SOLVAY SPECIALTY POLYMERS USA, LLC., Alpharetta, GA (US)

(72) Inventors: Armin Klesing, Niederbreitbach (DE); Shari W. Axelrad, Atlanta, GA (US); Mohammad Jamal El-Hibri, Atlanta, GA (US); Marc Schelles, Geel (BE); Nirupama Kenkare, Alpharetta, GA (US)

(73) Assignee: SOLVAY SPECIALTY POLYMERS USA, LLC., Alpharetta, GA (US)

(21) Appl. No.: 14/350,850

(22) PCT Filed: Oct. 11, 2012
(86) PCT No.: PCT/EP2012/070205

§ 371 Date: Apr. 10, 2014

Related U.S. Application Data
(60) Provisional application No. 61/546,153, filed on Oct. 12, 2011.

(30) Foreign Application Priority Data
Nov. 10, 2011 (EP) 11188635.4

(51) Int. Cl. C08L 81/06; C08J 9/00; C08L 79/08

(52) U.S. Cl. CPC C08L 81/06; C08L 79/08; C08J 9/0061
USPC 521/81; 521/134

(57) ABSTRACT

A foam material made from a composition (C) comprising a polyetherimide (PEI) and a poly(biphenyl ether sulfone) (P2).

This application claims priority to U.S. application No. 61/546,153 filed on 12 Oct. 2011 and to EP 11188635.4 filed 10 Nov. 2011, the whole content of each of these applications being incorporated herein by reference for all purposes.

### FIELD OF INVENTION

The present invention relates to polymeric foams, in particular, to polyetherimide/poly(biphenyl ether sulfone) foam materials. The invention further relates to methods of manufacturing polyetherimide/poly(biphenyl ether sulfone) foams and articles made therefrom.

### BACKGROUND OF THE INVENTION

In transport applications such as notably aircraft, automotive, train applications, polymeric materials must meet certain requirements. For example, thermal degradation characteristics are important considerations when specifying thermoplastic materials for use in said transport applications. To be permitted for use inside aircraft, engineering thermoplastics, including notably poly(aryl ether sulfone)s and polyetherimides, must meet certain requirements for flame resistance (e.g., flame retardancy), heat release during combustion, low moisture uptake and high resistance to aromatic amine hardeners used in expoxy resins. Poly(biphenyl ether sulfone)/polyetherimide blends are known to be particularly useful in the manufacture of extruded and molded goods for aircraft interior applications as it is disclosed in U.S. Pat. No. 6,482,880 B1.

In transport applications, notably aircraft, it is especially desirable to maximize weight reduction in a manner that does not compromise the strength and/or chemical properties of any component manufactured from a thermoplastic material. One way to reduce the weight of a particular aircraft component is to manufacture the component from a material having a relatively low density. By lowering the density of the materials used to make aircraft parts, improved weight/strength performance can be achieved. Of course, any reduction in weight may not come at the expense of a significant reduction in strength and/or chemical properties, such as notably their resistance to aircraft liquids. Flammability characteristics are especially important in aircraft applications and any weight reductions must not result in poorer thermal degradation characteristics.

It is known that the density of such thermoplastic compositions may be reduced by using the thermoplastic material in the form of foam. The use of foamed thermoplastic resins is already known in aircraft applications.

For example, a polyetherimide (PEI) foam has been available for a number of years for such transport applications including notably aircraft applications where electrical, mechanical and flame performance criteria can justify its application. US 2009/0163609 A1 describes notably polyetherimide foam materials having a broader range of possible foam densities.

However, it is known that PEI is a relatively brittle material and therefore the resulting PEI foam suffers from some drawbacks such as poor impact performance.

Due to the fact that PPSU has a relatively low modulus of elasticity of 350 kpsi, the PPSU foam will correspondingly suffer from some drawbacks such as having too low stiffness levels to be suitable for used in transport applications where high stiffness is required, such as for example structural aircraft applications.

However, it has been reported that the PPSU foam does not have a good resistance to aromatic amine hardeners for epoxy resins, such as Hexylow VRM34 which is used in structural aircraft composite applications.

There is thus still a high need for foam materials comprising thermoplastic compositions which are characterized by having a well defined and fairly homogeneous cell structure and which can overcome all these drawbacks, mentioned above, and offer an improved balance of mechanical properties such as high stiffness and strength properties at a low foam density, higher impact resistance to resist breakage in use high flame and heat resistance, and balanced resistance to aromatic amine hardeners for epoxy resins and other liquids that are typically used in the transport industry, like for example jet fuels and hydraulic fluids.

### SUMMARY OF INVENTION

The Applicant has now found surprisingly that certain foam materials based on poly(biphenyl ether sulfone)/polyetherimide polymeric materials and comprising optionally specific ingredients are particularly effective in fulfilling above mentioned requirements. Said foam materials have unexpectedly a well defined and homogeneous cell structure as evidenced by smaller foam cells, higher foam void contents, and/or greater uniformity of cell size.

The invention thus pertains to a foam material made from a composition [composition (C)] comprising a polyetherimide (PEI) and a poly(biphenyl ether sulfone) (P2).

Another aspect of the present invention is directed to a process for the manufacturing of the foam material.

Yet another aspect of the present invention is directed to an article that includes said foam material.

### DETAILED DESCRIPTION OF EMBODIMENTS

In the rest of the text, the expressions “PEI” and “poly(biphenyl ether sulfone) (P2)” are understood, for the purposes of the invention, both in the plural and the singular, that is to say that the foam material may comprise one or more than one PEI and one or more than one poly(biphenyl ether sulfone) (P2).

For the purpose of the present invention, a polyetherimide is intended to denote any polymer of which more than 50 wt. % of the recurring units (R1) comprise at least one aromatic ring, at least one imide group, as such and/or in its amic acid form, and at least one ether group [recurring units (R1a)].

Recurring units (R1a) may optionally further comprise at least one amide group which is not included in the amic acid form of an imide group.

The recurring units (R1) are advantageously selected from the group consisting of following formulae (I), (II), (III), (IV) and (V), and mixtures thereof:

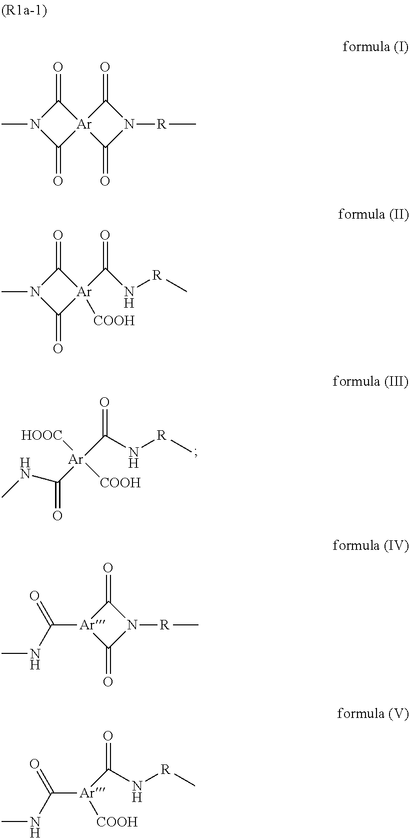

wherein
Ar is a tetravalent aromatic moiety and is selected from the group consisting of a substituted or unsubstituted, saturated, unsaturated or aromatic monocyclic and polycyclic group having 5 to 50 carbon atoms;
Ar′″ is a trivalent aromatic moiety and is selected from the group consisting of a substituted or unsubstituted, saturated, unsaturated or aromatic monocyclic and polycyclic group having 5 to 50 carbon atoms and
R is selected from the group consisting of substituted or unsubstituted divalent organic radicals, and more particularly consisting of (a) aromatic hydrocarbon radicals having 6 to 20 carbon atoms and halogenated derivatives thereof; (b) straight or branched chain alkylene radicals having 2 to 20 carbon atoms; (c) cycloalkylene radicals having 3 to 20 carbon atoms, and (d) divalent radicals of the general formula (VI):

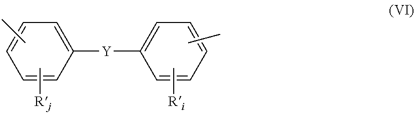

wherein Y is selected from the group consisting of alkylenes of 1 to 6 carbon atoms, in particular —C(CH₃)₂ and —CₙH₂ₙ— (n being an integer from 1 to 6); perfluoroalkylenes of 1 to 6 carbon atoms, in particular —C(CF₃)₂ and —CₙF₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and R′ is selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and i and j equal or different from each other, are independently 0, 1, 2, 3 or 4.
with the proviso that at least one of Ar, Ar′″ and R comprise at least one ether group.

Preferably, Ar is selected from the group consisting of those complying with the following formulae:

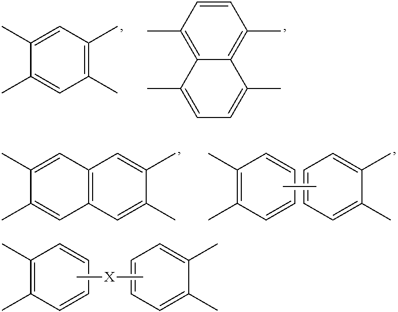

wherein X is a divalent moiety, having divalent bonds in the 3,3′, 3,4′, 4,3″ or the 4,4′ positions and is selected from the group consisting of alkylenes of 1 to 6 carbon atoms, in particular —C(CH₃)₂ and —CₙH₂ₙ— (n being an integer from 1 to 6); perfluoroalkylenes of 1 to 6 carbon atoms, in particular —C(CF₃)₂ and —CₙF₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, or X is a group of the formula O—Ar″—O; and wherein Ar″ is selected from the group consisting of those complying with following formulae (VII) to (XIII), and mixtures thereof:

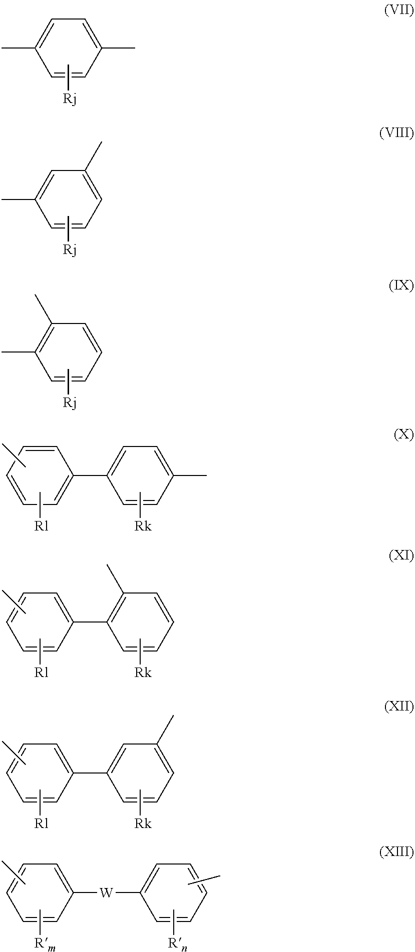

wherein R and R′, equal or different from each other, are independently selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j, k, l, n and m equal or different from each other, are independently 0, 1, 2, 3 or 4, and W is selected from the group consisting of alkylenes of 1 to 6 carbon atoms, in particular —C(CH₃)₂ and —CₙH₂ₙ— (with n being an integer from 1 to 6); perfluoroalkylenes of 1 to 6 carbon atoms, in particular —C(CF₃)₂ and —CₙF₂ₙ— (with n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; and —SO—.

Preferably, Ar′″ is selected from the group consisting of those complying with the following formulae:

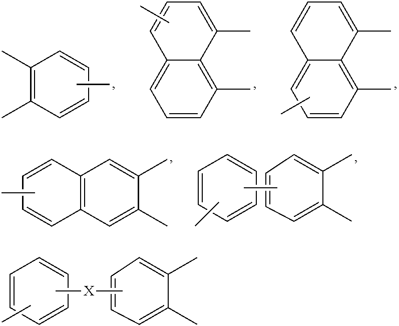

wherein X has the same meaning as defined above.

In a preferred specific embodiment, the recurring units (R1a) are selected from the group consisting of units of formula (XIV) in imide form, of corresponding units in amic acid forms of formulae (XV) and (XVI), and of mixtures thereof:

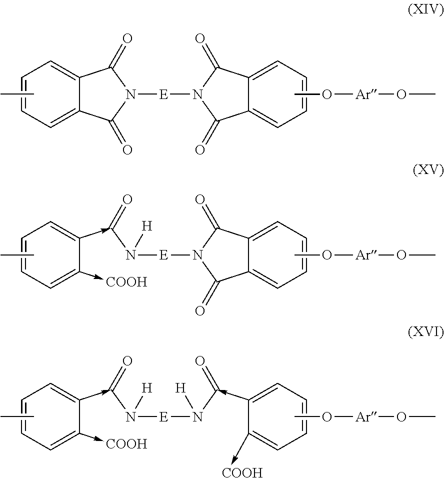

wherein:
the → denotes isomerism so that in any recurring unit the groups to which the arrows point may exist as shown or in an interchanged position;
Ar″ is selected from the group consisting of those complying with following formulae (VII) to (XIII)

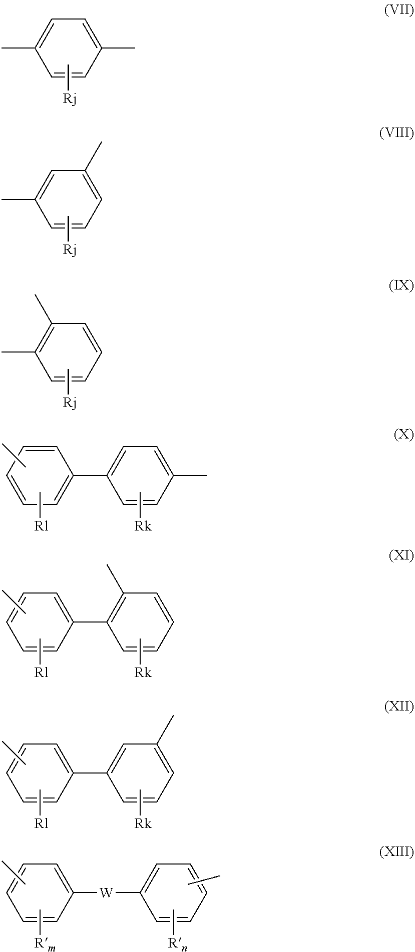

wherein R and R′, equal or different from each other, are independently selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j, k, l, n and m equal or different from each other, are independently 0, 1, 2, 3 or 4, and W is selected from the group consisting of alkylenes of 1 to 6 carbon atoms, in particular —C(CH₃)₂ and —CₙH₂ₙ— (n being an integer from 1 to 6); perfluoroalkylenes of 1 to 6 carbon atoms, in particular —C(CF₃)₂ and —CₙF₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; and —SO—; -E is selected from the group consisting of —CₙH₂ₙ— (n being an integer from 1 to 6), divalent radicals of the general formula (VI), as defined above, and those complying with formulae (XVII) to (X)

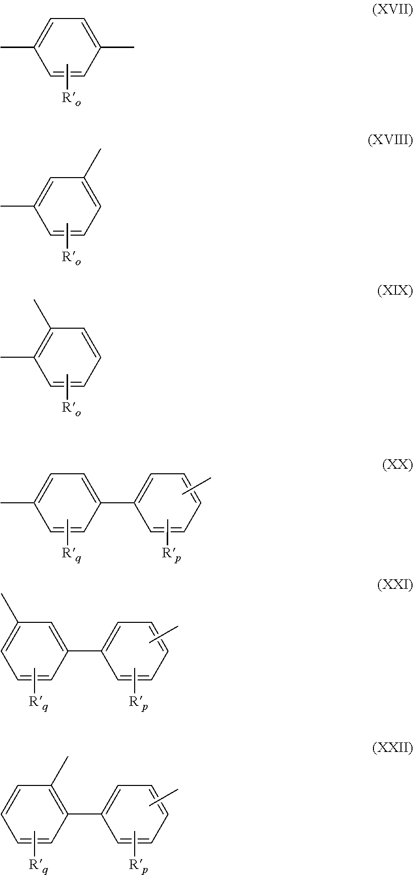

wherein R′ is selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and o, p, and q equal or different from each other, are independently 0, 1, 2, 3 or 4,

Preferably, E is selected from the group consisting of those complying with formulae (XVII) to (XIX), as defined above, more preferably, E is selected from the group consisting of unsubstituted m-phenylene and unsubstituted p-phenylene, and mixtures thereof.

Preferably, Ar″ is of the general formula (XIII), as detailed above; more preferably, Ar″ is

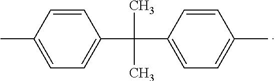

The polyetherimides wherein the recurring units (R1) are recurring units of formula (XIV) as such, in imide form, and/or in amic acid forms [formulae (XV) and (XVI)], as defined above, may be prepared by any of the methods well-known to those skilled in the art including the reaction of any aromatic bis(ether anhydride)s of the formula

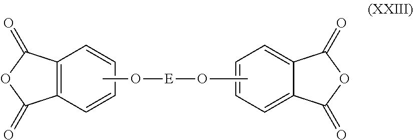

where E is as defined hereinbefore, with a diamino compound of the formula

H₂N—Ar″—NH₂ (XXIV)

where Ar″ is as defined hereinbefore. In general, the reactions can be advantageously carried out employing well-known solvents, e.g., o-dichlorobenzene, m-cresol/toluene, N,N-dimethylacetamide, etc., in which to effect interaction between the dianhydrides and diamines, at temperatures of from about 20° C. to about 250° C.

Alternatively, these polyetherimides can be prepared by melt polymerization of any dianhydrides of formula (XXIII) with any diamino compound of formula (XXIV) while heating the mixture of the ingredients at elevated temperatures with concurrent intermixing.

The aromatic bis(ether anhydride)s of formula (XXIII) include, for example:

2,2-bis[4-(2,3-dicarboxyphenoxy)phenyl]propane dianhydride; 4,4′-bis(2,3-dicarboxyphenoxy)diphenyl ether dianhydride; 1,3-bis(2,3-dicarboxyphenoxy)benzene dianhydride; 4,4′-bis(2,3-dicarboxyphenoxy)diphenyl sulfide dianhydride; 1,4-bis(2,3-dicarboxyphenoxy)benzene dianhydride; 4,4′-bis(2,3-dicarboxyphenoxy)benzophenone dianhydride; 4,4′-bis(2,3-dicarboxyphenoxy)diphenyl sulfone dianhydride; 2,2-bis[4 (3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 1,3-bis(3,4-dicarboxyphenoxy)benzene dianhydride; 1,4-bis(3,4-dicarboxyphenoxy)benzene dianhydride; 4,4′-bis(3,4-dicarboxyphenoxy)benzophenone dianhydride; 4-(2,3-dicarboxyphenoxy)-4′-(3,4-dicarboxyphenoxy)diphenyl-2,2-propane dianhydride; etc. and mixtures of such dianhydrides.

The organic diamines of formula (XX) include, for example, m-phenylenediamine, p-phenylenediamine, 2,2-bis(p-aminophenyl)propane, 4,4′-diaminodiphenyl-methane, 4,4′-diaminodiphenyl sulfide, 4,4′-diamino diphenyl sulfone, 4,4′-diaminodiphenyl ether, 1,5-diaminonaphthalene, 3,3′-dimethylbenzidine, 3,3′-dimethoxybenzidine, and mixtures thereof.

In a preferred embodiment, the organic diamines of formula (XX) is chosen from a group selected from m-phenylenediamine and p-phenylenediamine and mixture thereof.

In a most preferred embodiment, the recurring units (R1a) are recurring units selected from the group consisting of those of formula (XXV) in imide form, their corresponding amic acid forms of formulae (XXVI) and (XXVII), and mixtures thereof:

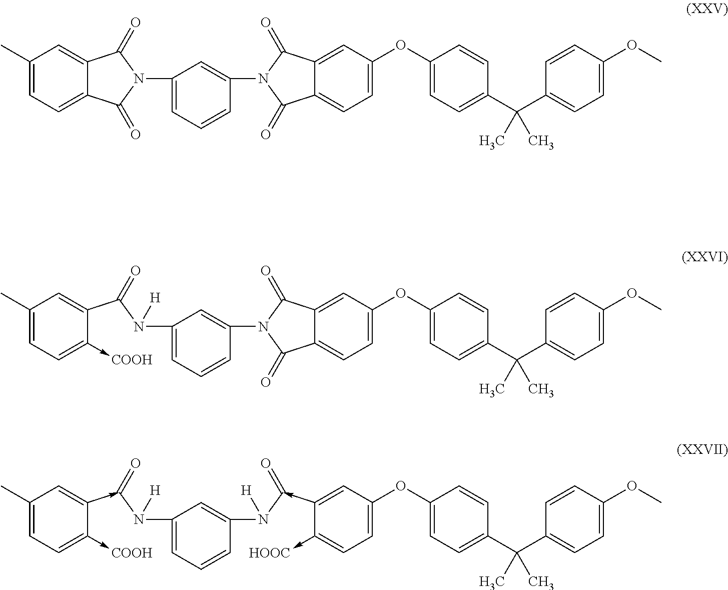

wherein in formulae (XXVI) and (XXVII) the → denotes isomerism so that in any recurring unit the groups to which the arrows point may exist as shown or in an interchanged position.

In another most preferred embodiment, the recurring units (R1a-4) are recurring units selected from the group consisting of those of formula (XXVIII) in imide form, their corresponding amic acid forms of formulae (XXIX) and (XXX), and mixtures thereof:

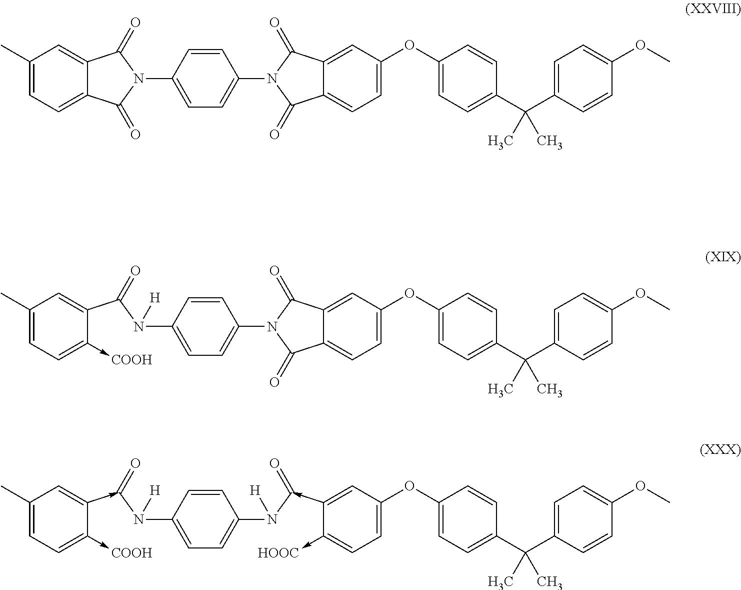

wherein in formulae (XXIX) and (XXX) the → denotes isomerism so that in any recurring unit the groups to which the arrows point may exist as shown or in an interchanged position.

Preferably more than 75 wt. % and more preferably more than 90 wt. % of the recurring units of the PEI are recurring units (R1). Still more preferably, essentially all, if not all, the recurring units of the PEI are recurring units (R1).

In a preferred embodiment of the present invention, more than 75 wt. % more preferably more than 90 wt. %, more preferably more than 99 wt. %, even more preferably all the recurring units of the PEI are recurring units selected from the group consisting of those in imide form of formula (XXV), their corresponding amic acid forms of formulae (XXVI) and (XXVII), and mixtures thereof.

In another preferred embodiment of the present invention, more than 75 wt. % more preferably more than 90 wt. %, more preferably more than 99 wt. %, even more preferably all the recurring units of the PEI are recurring units selected from the group consisting of those in imide form of formula (XXVIII), their corresponding amic acid forms of formulae (XXIX) and (XXX), and mixtures thereof.

Such aromatic polyimides are notably commercially available from Sabic Innovative Plastics as ULTEM® polyetherimides.

The compositions can comprise one and only one PEI. Alternatively, they can comprise two, three, or even more than three PEI.

Generally, PEI polymers useful in the present invention have a melt index of 0.1 to 10 grams per minute (g/min), as measured according to ASTM D1238 at 295° C., using a 6.6 kilogram (kg) weight.

In a specific embodiment, the PEI polymer has a weight average molecular weight (Mw) of 10,000 to 150,000 grams per mole (g/mole), as measured by gel permeation chromatography, using a polystyrene standard. Such PEI polymers typically have an intrinsic viscosity greater than 0.2 deciliters per gram (dl/g), beneficially 0.35 to 0.7 dl/g measured in m-cresol at 25° C.

The PEI polymers have been found particularly suitable for the thermoplastic compositions comprised in the foam material of the present invention in view of their advantageous high modulus of about 450 kpsi, a remarkable elevated thermal resistance, high dielectric strength, a broad chemical resistance profile, and its good melt processability.

The poly(biphenyl ether sulfone) (P2) of the invention is intended to denote a polycondensation polymer of which more than 50 wt. % of the recurring units are recurring units (R2) of one ore more formulae containing at least one biphenylene group preferably selected from the group consisting of those complying with following formulae:

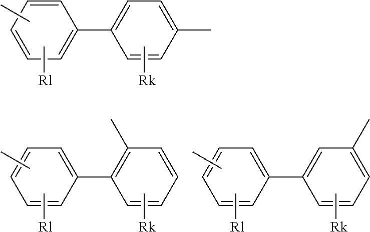

wherein R is selected from the group consisting of:

hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j, k and l equal or different from each other, are independently 0, 1, 2, 3 or 4; and
at least one ether group (—O—) and at least one sulfone group (—SO₂—).

The recurring units (R) are advantageously recurring units of formula (A) as shown below:

—Ar¹-(T-Ar²)ₙ—O—Ar³—SO₂-[Ar⁴-(T-Ar²)ₙ—SO₂]ₘ—Ar⁵—O— (formula A)

wherein:

Ar¹, Ar², Ar³, Ar⁴, and Ar⁵, equal to or different from each other and at each occurrence, are independently an aromatic mono- or polynuclear group; with the proviso that at least one Ar¹ through Ar⁵ is an aromatic moiety containing at least one biphenylene group, selected from the group consisting of those complying with the following formulae:

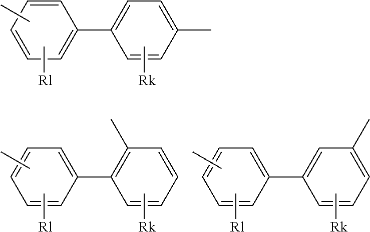

wherein R is selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and k and l equal or different from each other, are independently 0, 1, 2, 3 or 4, and

each of T, equal to or different from each other, is a bond or a divalent group optionally comprising one or more than one heteroatom;

n and m, equal to or different from each other, are independently zero or an integer of 1 to 5;

Preferably, Ar¹, Ar², Ar³, Ar⁴, Ar⁵ are equal or different from each other and are aromatic moieties preferably selected from the group consisting of those complying with following formulae:

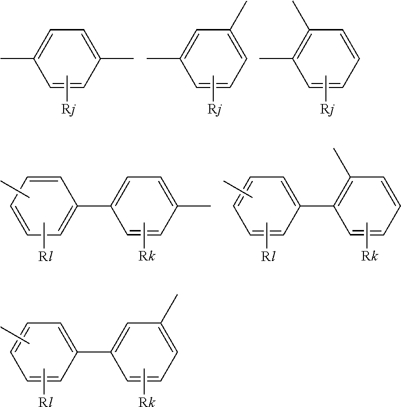

wherein R is selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j, k and l equal or different from each other, are independently 0, 1, 2, 3 or 4, and with the proviso that at least one Ar¹ through Ar⁵ is an aromatic moiety containing at least one biphenylene group, selected from the group consisting of those complying with following formulae:

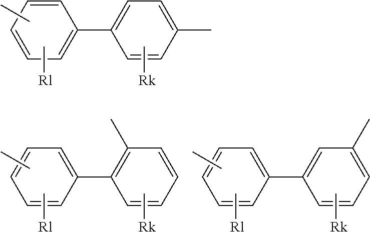

wherein R is selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and k and l equal or different from each other, are independently 0, 1, 2, 3 or 4.

Preferably, each of T, equal to or different from each other, is selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —R^{a}C═CR^{b}—; where each R^{a} and R^{b}; independently of one another, is a hydrogen or a C₁-C₁₂-alkyl, C₁-C₁₂-alkoxy, or C₆-C₁₈-aryl group; —(CH₂)ₙ— and —(CF₂)ₙ— with n=integer from 1 to 6, or an aliphatic divalent group, linear or branched, of up to 6 carbon atoms; and mixtures thereof.

More preferably, recurring units (R²) are selected from the group consisting of formulae (B) to (F), as below detailed, and mixtures thereof:

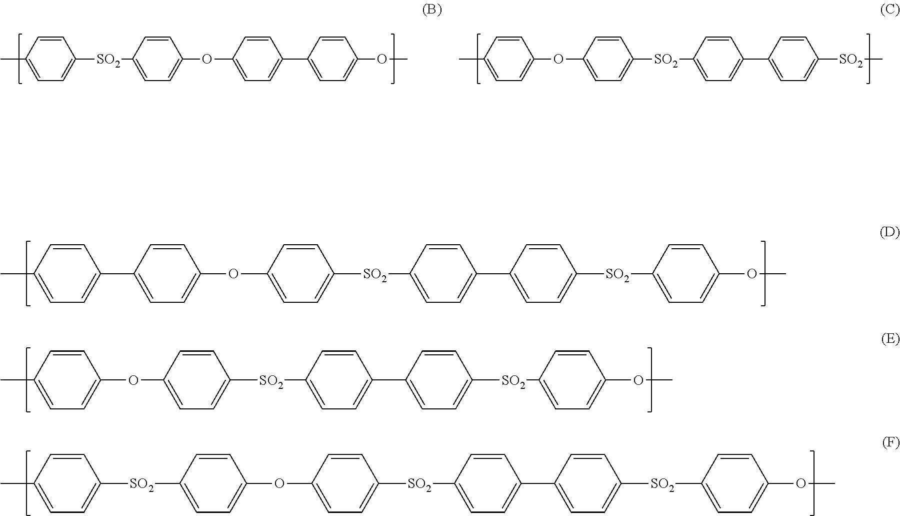

Still more preferably, recurring units (R2) are:

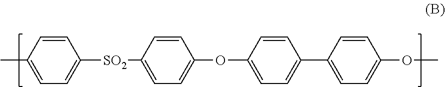

For the purpose of the present invention, a polyphenylsulfone (PPSU) polymer is intended to denote any polymer of which more than 50 wt. % of the recurring units are recurring units (R2) of formula (B).

The poly(biphenyl ether sulfone) (P2) may be notably a homopolymer, a random, alternate or block copolymer. When the poly(biphenyl ether sulfone) (P2) is a copolymer, its recurring units may notably be composed of (i) recurring units (R2) of at least two different formulae selected from formulae (B) to (F), or (ii) recurring units (R2) of one or more formulae (B) to (F) and recurring units (R2*), different from recurring units (R2), such as:

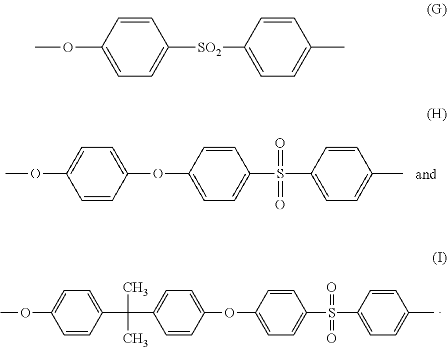

Preferably more than 75 wt. %, preferably more than 85 wt. %, preferably more than 95 wt. %, preferably more than 99 wt. % of the recurring units of the poly(biphenyl ether sulfone) (P2) are recurring units (R2). Still more preferably, all the recurring units of the poly(biphenyl ether sulfone) (P2) are recurring units (R2). Most preferably, all the recurring units of the poly(biphenyl ether sulfone) (P2) are recurring units (R2).

In a preferred embodiment of the present invention, more than 75 wt. % more preferably more than 90 wt. %, more preferably more than 99 wt. %, even more preferably all the recurring units of the poly(biphenyl ether sulfone) (P2) are of formula (B).

RADEL® R polyphenylsulfone from Solvay Advanced Polymers, L.L.C. is an example of a PPSU homopolymer.

The poly(biphenyl ether sulfone) (P2) can be prepared by any method. Methods well known in the art are those described in U.S. Pat. Nos. 3,634,355; 4,008,203; 4,108,837 and 4,175,175, the whole content of which is herein incorporated by reference.

The molecular weight of the poly(biphenyl ether sulfone) (P2), as indicated by reduced viscosity data in an appropriate solvent such as methylene chloride, chloroform, N-methylpyrrolidone, or the like, can be greater than or equal to 0.3 dl/g, or, more specifically, greater than or equal to 0.4 dl/g and, typically, will not exceed 1.5 dl/g.

The poly(biphenyl ether sulfone) (P2) weight average molecular weight can be 10,000 to 100,000 grams per mole (g/mol) as determined by gel permeation chromatography using ASTM D5296 with polystyrene standards. In some embodiments the poly(biphenyl ether sulfone) (P2) weight average molecular weight can be 20,000 to 70,000 grams per mole (g/mol). The poly(biphenyl ether sulfone) (P2) may have glass transition temperatures of 180 to 250° C.

Poly(biphenyl ether sulfone) (P2) polymers have been found particularly suitable for the thermoplastic compositions comprised in the foam material of the present invention due to their advantageous high toughness and impact strength, high impact resistance, high chemical resistance, exceptional hydrolytic stability, and very good inherent flammability resistance.

The expression ‘consisting essentially of’ is used in combination with the PE1 or P2 polymers within the context of the present invention for defining constituents of a polymer to take into account end chains, defects, irregularities and monomer rearrangements which might be comprised in said polymers in minor amounts, without this modifying essential properties of the polymer.

In one preferred embodiment of the present invention, the foam material made from a composition [composition (C)] comprising a polyetherimide (PEI), wherein more than 75 wt. % of the recurring units of the PEI are recurring units (R1) selected from the group consisting of those of formula (XXV) in imide form, corresponding amic acid forms of formulae (XXVI) and (XXVII), and mixtures thereof:

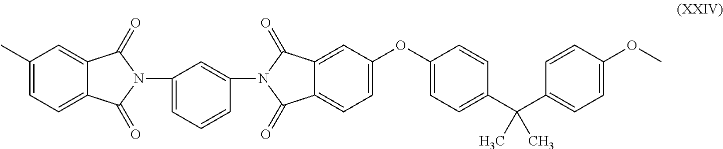

and a poly(biphenyl ether sulfone) (P2), wherein more than 75 wt. % of the recurring units of the poly(biphenyl ether sulfone) (P2) are recurring units (R2) of formula (B)

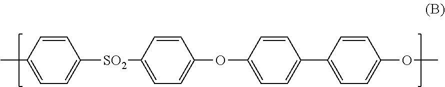

In another preferred embodiment of the present invention, the foam material made from a composition [composition (C)] comprising a polyetherimide (PEI), wherein more than 75 wt. % of the recurring units of the PEI are recurring units (R1) selected from the group consisting of those in imide form of formula (XXVIII), their corresponding amic acid forms of formulae (XXIX) and (XXX), and mixtures thereof:

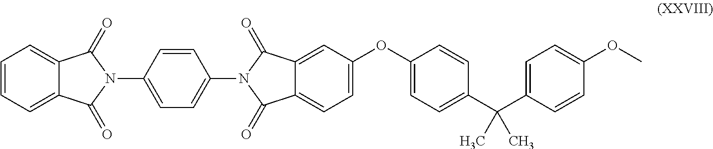

and a poly(biphenyl ether sulfone) (P2), wherein more than 75 wt. % of the recurring units of the poly(biphenyl ether sulfone) (P2) are recurring units (R2) of formula (B)

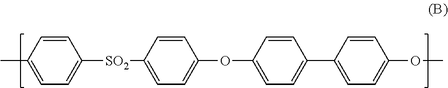

### The Composition (C)

The weight of the polyetherimide, based on the total weight of the polyetherimide and the poly(biphenyl ether sulfone) (P2), is advantageously above 10%, preferably above 20%, more preferably above 30% and still more preferably above 40%. On the other hand, the weight of the polyetherimide, based on the total weight of the polyetherimide and the poly(biphenyl ether sulfone) (P2), is advantageously below 90%, preferably below 80%, is more preferably below 75% and still more preferably below 70%.

The total weight of the polyetherimide and the poly(biphenyl ether sulfone) (P2), based on the total weight of the composition (C), is advantageously above 50%, preferably above 80%; more preferably above 90%; more preferably above 95% and more preferably above 99%.

If desired, the composition (C) consists of the polyetherimide and the poly(biphenyl ether sulfone) (P2).

### Optional Ingredients of the Composition (C)

The composition (C) can further contain one or more ingredients other than the polyetherimide and the poly(biphenyl ether sulfone) (P2).

The composition (C) may further contain conventional ingredients of polymeric compositions, additives such as UV absorbers; stabilizers such as light stabilizers and others; lubricants; plasticizers; pigments; dyes; colorants; anti-static agents; nucleating agents, foaming agents; blowing agents; metal deactivators; and combinations comprising one or more of the foregoing additives. Antioxidants can be compounds such as phosphites, phosphorates, hindered phenols or mixtures thereof. Surfactants may also be added to help nucleate bubbles and stabilize them during the bubble growth phase of the foaming process.

The weight of said conventional ingredients, based on the total weight of polymer composition (C), ranges advantageously from 0 to 15%, preferably from 0 to 10% and more preferably from 0 to 5%.

If desired, the composition (C) comprises more than 85 wt. % of the polyetherimide and the poly(biphenyl ether sulfone) (P2) with the proviso that the polyetherimide and the poly(biphenyl ether sulfone) (P2) are the only polymeric components in the composition (C) and one or more optional ingredients such as additives; stabilizers; lubricants; plasticizers; pigments; dyes; colorants; anti-static agents; nucleating agents, foaming agents; blowing agents; metal deactivators; antioxidants and surfactants might be present therein, without these components dramatically affecting relevant mechanical and toughness properties of the composition (C).

The expression ‘polymeric components’ is to be understood according to its usual meaning, i.e. encompassing compounds characterized by repeated linked units, having typically a molecular weight of 2 000 or more.

The composition (C) can be prepared by a variety of methods involving intimate admixing of the polymer materials with any optional ingredient, as detailed above, desired in the formulation, for example by melt mixing or a combination of dry blending and melt mixing. Typically, the dry blending of the PEI polymer, poly(biphenyl ether sulfone) (P2) and all other optional ingredients, as above details, is carried out by using high intensity mixers, such as notably Henschel-type mixers and ribbon mixers.

So obtained powder mixture can comprise the PEI polymer and the poly(biphenyl ether sulfone) (P2) in the weight ratios as above detailed, suitable for obtaining effective foaming, or can be a concentrated mixture to be used as masterbatch and diluted in further amounts of the PEI polymer and the poly(biphenyl ether sulfone) (P2) in subsequent processing steps.

It is also possible to manufacture the composition of the invention by further melt compounding the powder mixture as above described. As said, melt compounding can be effected on the powder mixture as above detailed, or preferably directly on the PEI polymer, the poly(biphenyl ether sulfone) (P2) and any other possible ingredient, Conventional melt compounding devices, such as co-rotating and counter-rotating extruders, single screw extruders, co-kneaders, disc-pack processors and various other types of extrusion equipment can be used. Preferably, extruders, more preferably twin screw extruders can be used.

Specially designed extruders, i.e. extruders specifically designed to effectively control temperature such that further processes such as foaming is not prematurely initiated and such that the composition may be melted, blended, extruded and palletized without premature foaming of the composition, are particularly preferred. The design of the compounding screw, e.g. flight pitch and width, clearance, length as well as operating conditions will be advantageously chosen so that sufficient heat and mechanical energy is provided to advantageously fully melt the powder mixture or the ingredients as above detailed and advantageously obtain a homogeneous distribution of the different ingredients, but still mild enough to advantageously keep the processing temperature of the composition below that in which foaming may be prematurely initiated, in case optional chemical foaming ingredients are comprised in the composition. Provided that the processing temperature is kept well above the softening point of the PEI polymer and that of the poly(biphenyl ether sulfone) (P2) and, when chemical foaming agent(s) are comprised, below the decomposition temperature of any of said chemical foaming components possibly present, it is advantageously possible to obtain strand extrudates of the composition (C) of the invention which have not undergone significant foaming. Such strand extrudates can be chopped by means e.g. of a rotating cutting knife aligned downwards the die plate, generally with an underwater device, which assures perfect cutting knife to die plate alignment, and collected under the form of pellets or beads. Thus, for example composition (C) which may be present in the form of pellets or beads can then be further used for the manufacture of the foam material.

The Foam Material

The Applicant has surprisingly found that the composition (C), as mentioned above, is effective in providing foam materials having high void content, low apparent density and substantially uniform cell sizes.

For the purpose of the present invention, the term “substantially uniform cell size” is intended to denote a foam material wherein the magnitude of one standard deviation of the cell size frequency distribution is at most 40% of the value of the estimated mean cell size, so as an example, a foam with an estimated mean cell size of 100 micrometers and a standard deviation of 35 micrometers in cell size distribution would fall within the scope of the above definition for “substantially uniform cell size”.

It has been found that the foam materials of the present invention, endowed by having uniform cell size, have improved mechanical properties since larger cells act as a weak point in the foam, which may initiate a failure.

The invention further pertains to a process for making a foam material by foaming the composition (C), as detailed above.

The foam material of the present invention may be formed using any foaming processes, which is capable of forming the foam material. Suitable foaming processes that may be used in the present invention include, but are not limited to, pressure cell processes, autoclave processes, extrusion processes, direct (variotherm) injection processes and bead foaming.

The extrusion process is most preferred.

A pressure cell process, for example, is carried out batchwise and in which the composition (C) is initially formed and is then charged with a gas under a pressure that is higher than atmospheric pressure and at a temperature that is below the glass transition temperature of the polymer/gas mixture. The temperature is then raised to a temperature that is above the glass transition temperature but below the critical temperature of the polymer/gas mixture, by immersing in a heating bath, and then the gas is driven out of the formed body to produce the desired foam structure. Transfer from the pressure cell to the heating bath must be carried out as fast as possible, considering that the dissolved gas can quickly diffuse out of the polymer at ambient pressure. After foaming, the polymeric formed body must be quenched in an ethanol/water mixture at about 20° C.

In an autoclave process, for example, the composition (C) is charged with a gas at a temperature that is above the glass transition temperature of the polymer/gas mixture and foaming is induced by spontaneous release of the pressure. In contrast to the pressure cell process, in which the gas-charged polymer is normally transferred to a heating bath to raise the temperature to above the glass transition temperature but below the critical temperature of the polymer/gas mixture, the autoclave process does not need a heating stage as the polymer is already at the required temperature that is above the glass transition temperature on charging with the gas.

An extrusion process, in contrast to the two processes described above, is a continuous process. In general, in the extrusion process, the foam is formed by melting a thermoplastic, or a mixture comprising a thermoplastic (e.g. the composition (C) and a nucleating agent in the form of a pellet or a bead), giving a melt, whereby said melt is mixed with at least one blowing agent under pressure. At the exit of the extruder, during depressurization, the blowing agent vaporizes and, by absorbing heat of evaporation, rapidly cools the melt thereby forming the foam.

Any suitable extrusion equipment capable of processing composition (C) can be used for the extrusion. For example, single or multiple-screw extruders can be used, with a tandem extruder being preferred.

The thermoplastic, or mixture comprising the thermoplastic are atvantageously dried before melting so that the moisture content of said thermoplastic, or mixture is less than 2000 ppm, preferably less than 1500 ppm, more preferably less than 1000 ppm relative the total weight of the thermoplastic or mixture comprising the thermoplastic.

In a specific preferred embodiment, a mixture comprising the composition (C) and any nucleating agent are first melt blended together in a primary extruder. The blowing agent is then fed into the primary extruder and mixed into the melt blend under high pressure and temperature in the last sections of the primary extruder. The melt is then fed under pressure to a secondary extruder, which is used to cool the material to be foamed and transport it through a die to a calibrator to form the foam material. The calibrator helps to control the cooling rate of the foaming mixture. Therefore, it is beneficial in helping to control the thickness, width and density of the foam material. The die is operated at a specific temperature range and pressure range to provide the necessary melt strength and to suppress premature foaming in the die. In one embodiment, a single screw extruder is used for both the primary extruder and the secondary extruder. In an alternative embodiment, a twin-screw extruder is used for both the primary extruder and the secondary extruder. In yet another alternative embodiment, a single screw extruder is used for one of the primary extruder or the secondary extruder and a twin-screw extruder is used for the other.

In the process of the invention, a blowing agent, or blends of blowing agents, can advantageously be used in different amounts depending on the desired density of the foam. In one preferred embodiment of the present invention, the amount used of the blowing agent is from 0.5 to 15 percent by weight, preferably from 1 to 12 percent by weight, particularly preferably from 3 to 10 percent by weight, based in each case on the total weight of the composition (C).

In general, a larger amount of blowing agent may be used for embodiments where lower density foams are to be formed.

In general, the blowing agent is selected to be sufficiently soluble to grow the voids into the bubbles that form a foam material having the selected density. As a result, if all of the parameters including solubility of the blowing agent with the PEI polymer and the poly(biphenyl ether sulfone) (P2) melt (at pressure, temperature and shear rate) are balanced and the walls of the bubbles are sufficiently stable such that they do not rupture or coalesce until the viscosity/melt strength of the resin/blowing agent is strong enough to form a stable foam as it cools, the result is a good, uniform, small celled foam having a selected density.

In general, the type of foam to be produced may also vary depending on other factors such as the presence of nucleating agent particles, the loading and/or process conditions, and the type of equipment used to form the foam materials.

In the process of the invention, a nucleating agent, or blends of nucleating agents, can advantageously be used and is/are preferably used in addition to the blowing agent, or blends of blowing agents. In general, the nucleating agent helps control the foam structure by providing a site for bubble formation, and the greater the number of sites, the greater the number of bubbles and the less dense the final product can be, depending on processing conditions.

Suitable nucleating agent that may be used in the present invention include, but are not limited to, metallic oxides such as titanium dioxide, clays, talc, silicates, silica, aluminates, barites, titanates, borates, nitrides, notably boron nitride, and even some finely divided, unreactive metals, carbon-based materials (such as diamonds, carbon black, nanotubes and graphenes) or combinations including at least one of the foregoing agents. In alternative embodiments, silicon and any crosslinked organic material that is rigid and insoluble at the processing temperature may also function as nucleating agents.

In alternative embodiments, other fillers may be used provided they have the same effect as a nucleating agent in terms of providing a site for bubble formation. This includes fibrous fillers such as aramid fibers, carbon fibers, glass fibers, mineral fibers, or combinations including at least one of the foregoing fibers. Some nano-fillers and nano-reinforcements can also be used as nucleating agents. These include such materials as nano-silicates, nano-clays, carbon nanofibers and carbon nanotubes as well as graphenes and multi-layered graphitic nano-platelets.

In a preferred embodiment, the nucleating agent is preferably used in the following amounts: advantageously from 0.1 to 5% by weight, preferably from 0.2 to 3% by weight, more preferably from 0.5 to 2% by weight based in each case on the total weight of the composition (C).

Having regards to the nature of the blowing agent, the foaming process may be a chemical or a physical foaming process.

In one preferred embodiment, the foaming process is a physical foaming process.

In a physically foaming process, use is made of physical foaming ingredients, such as physical blowing agents and optionally nucleating agents.

Physical foaming agents generally refer to those compounds that are in the gaseous state in the foaming conditions (generally high temperature and pressure) because of their physical properties.

The physical foaming agents can be fed to the equipment, wherein foaming takes place, either in their gaseous form, or in any other form, from which a gas will be generated via a physical process (e.g. evaporation, desorption). Otherwise, physical foaming may be included in the pre-formed composition (C), to be introduced in the foaming equipment.

In the process of the present invention, any conventional physical blowing agent can be used such as inert gases, e.g. CO₂, nitrogen, argon; hydrocarbons, such as propane, butane, pentane, hexane; aliphatic alcohols, such as methanol, ethanol, propanol, isopropanol, butanol; aliphatic ketones, such as acetone, methyl ethyl ketone; aliphatic esters, such as methyl and ethyl acetate; fluorinated hydrocarbons, such as 1,1,1,2-tetrafluoroetha-ne (HFC 134a) and difluoroethane (HFC 152a); and mixtures thereof.

It is understood that as the physical blowing agent is supplied in fluid form to a melt, it advantageously generates bubbles. This may also be realized in extrusion devices.

In an alternative embodiment of the present invention, the foaming process is a chemical foaming process.

In a chemical foaming process, use is generally made of a chemical foaming agent, in particular a chemical blowing agent.

Chemical foaming agents generally refer to those compositions which decompose or react under the influence of heat in foaming conditions, to generate a foaming gas.

Chemical foaming agents can be added to a melt thereby generating in situ the foaming gas or alternatively the generated foaming gas can be added to the melt. This may also be realized in extrusion devices.

Suitable chemical foaming agents include notably simple salts such as ammonium or sodium bicarbonate, nitrogen evolving foaming agents; notably aromatic, aliphatic-aromatic and aliphatic azo and diazo compounds, such as azodicarbonamide and sulphonhydrazides, such as benzene sulphonhydrazide and oxy-bis(benzenesulphonhydrazide). Said chemical foaming agents can optionally be mixed with suitable activators, such as for example amines and amides, urea, sulphonhydrazides (which may also act as secondary foaming agent); and the like.

While the finished foam material is substantially free of the blowing agents, it is contemplated that residual amounts of the one or more blowing agents may remain in the foam material, although these residual amounts are not sufficient to adversely affect the foam characteristics of the foam material.

In alternative embodiments, any of the residual blowing agent may be reduced by exposing the foam material further to a heat cycle.

The foam material of the present invention has advantageously a density in the range from 10 to 500 kg/m³, preferably from 20 to 400 kg/m³, more preferably from 20 to 250 kg/m³, even more preferably from 25 to 250 kg/m³.

The foam material of the present invention has advantageously an average cell size of less than 1000 μm, preferably less than 500 μm, preferably less than 300 μm and more preferably less than 250 μm.

When the foaming process is an extrusion process, the cell morphology of the foam material in the machine direction (or extrusion direction) can be different from the cell morphology of the foam material in the transverse direction.

The foam material when obtained from the extrusion process has advantageously cell sizes in the machine direction of less than 1000 μm, preferably less than 500 μm, and more preferably less than 270 μm.

The foam material when obtained from the extrusion process has advantageously cell sizes in the transverse direction of less than 1000 μm, preferably less than 500 μm, and more preferably less than 300 μm.

In the case of foams made by extrusion process, the average cell size refers to the average of the cell size value in the transverse direction and the cell size value in the machine direction.

The density can be measured according to ASTM D1622.

The cell size can be measured using optical or scanning electron microscopy.

The foam materials of the present invention offer high stiffness and strength properties at a given foam density in comparison with poly(biphenyl ether sulfone) (P2) foams, and higher impact resistance than PEI foams, making the poly(biphenyl ether sulfone) (P2)/PEI foam materials of the present invention are especially useful for example in aircraft applications.

The poly(biphenyl ether sulfone) (P2)/PEI foam materials, as formed may be in a variety of shapes, such as foam boards, foam sheets, foam film, foam tubes or any shape possible as determined by the skilled in the art using standard techniques and routine work, temperature, power and residence time of the composition in the extruder so as to obtain final desired shaped foamed parts having the desired void fraction or foaming level.

An aspect of the present invention also provides an article comprising at least one component comprising the foam material, detailed as above, which provides various advantages over prior art parts and articles, in particular higher stiffness and improved strength properties at a given foam density and higher impact resistance. Preferably, the article or part of the article consists of the foam material as above detailed.

In a particular embodiment, the article is an aircraft structural component. a structural or secondary aircraft component

In another specific embodiment, the aircraft structural component is a sandwich panel comprised of a core comprising the foam material of the present invention and laminated skin layers comprised of a continuous fiber-reinforced thermoset or thermoplastic composite.

The use of the foam materials of the present invention as part of an aircraft structural component as described above are also objects of the present invention.

It is known in the art that epoxy resin systems such as Hexylow VRM34, (a two-part, amine-cured epoxy system) are used in vacuum assisted resin transfer molding (VARTM) processes, used in the manufacturing of aircraft structural components such as wing and fuselage structural elements

The applicant has surprisingly found that the poly(biphenyl ether sulfone) (P2)/PEI foams exhibit an improved resistance to epoxy resin systems generally used in the manufacturing of said aircraft structural components.

Should the disclosure of any patents, patent applications, and publications which are incorporated herein by reference conflict with the description of the present application to the extent that it may render a term unclear, the present description shall take precedence.

### EXAMPLES

The invention will be now described in more details with reference to the following examples, whose purpose is merely illustrative and not intended to limit the scope of the invention.

Raw Materials

Titanium Dioxide:—Tipure® R-105 titanium dioxide, a rutile TiO₂ manufactured by the chloride process, treated with silica and alumina.
Ultem™ 1000 PEI (from Sabic Innovative Plastics)
RADEL® R-5100 NT polyphenylsulfone (from Solvay Advanced Polymers)
Veradel® A-201 NT polyethersulfone (from Solvay Advanced Polymers)
Udel® P-1700 NT polysulfone (from Solvay Advanced Polymers)

(I) General Procedure for the Preparation of Material for Foaming a First Set of Examples

A polymer or polymer mixture is compounded with 2 parts of TiO₂ per hundred parts of resin. Compounding into pellets is performed on a Berstorff 25 mm twin screw extruder having an L/D ratio of 40:1 and eight barrel sections, of which sections 2-8 are equipped with heating and cooling. In each case, the base polymer pellets and the TiO₂ are first tumble-blended for twenty minutes and then the mix is fed to the throat of the extruder. The extruder is set at a barrel temperature of 330° for barrel sections 2-8. The die temperature is set at 340° C. and a screw speed of 200 rpm is used along with a throughput rate of 25 lb/hr for each of the four formulations. Vacuum venting of the melt is performed at barrel section 7. The extrudate from the extruder in each case is cooled in a water trough and then pelletized. The pellets produced from the formulation are dried at temperatures between 130 and 180° C. for 8 hours and are next fed to the foaming set up which consisted of two 19 mm diameter Brabender single screw extruders that are set in series. The first extruder (A extruder) output feeds via a melt pump directly into the second (B extruder) in a T-configuration. The A extruder has an L/D ratio of 20 while the B extruder has an L/D of 25. The B extruder is equipped with a 1 mm strand die of circular cross section. The pellets produced from the formulation is fed to the A extruder where it is melted. The injection point for the blowing agent is located at two thirds of the way down the axial length of the A extruder. Isopropanol is metered and injected into the polymer melt at pressures of 60-300 bar depending on the present melt pressure in the extruder The homogenized polymer melt and isopropanol mixture is then metered using the melt pump into the B extruder where the mixture is cooled down to temperatures between 180 and 230° C.

### Comparative Example 1

A foamed strand 4-8 mm in diameter is produced from Ultem™ 1000 PEI (from Sabic Innovative Plastics) according to the general procedure, as described above. The mixture in extruder B is cooled down to a temperature of about 220-240° C.

### Comparative Example 2

A foamed strand 4-8 mm in diameter is produced from RADEL® R-5100 NT polyphenylsulfone (from Solvay Advanced Polymers) according to the general procedure, as described above. The mixture in extruder B is cooled down to a temperature of about 220-240° C.

### Comparative Example 3

A foamed strand 4-8 mm in diameter is produced from Veradel® A-201 NT polyethersulfone (from Solvay Advanced Polymers) according to the general procedure, as described above. The mixture in extruder B is cooled down to a temperature of about 220-240° C.

### Comparative Example 4

A foamed strand 4-8 mm in diameter is produced from Udel® P-1700 NT polysulfone (from Solvay Advanced Polymers) according to the general procedure, as described above. The mixture obtained in the B extruder is cooled down to a temperature of about 190-210° C.

### Example 5

A foamed strand 4-8 mm in diameter is produced from the polymer mixture Ultem™ 1000 PEI/RADEL® R-5100 NT polyphenylsulfone in a 50/50 ratio according to the general procedure, as described above. The mixture obtained in the B extruder is cooled down to a temperature of about 220-240° C. Scanning electron microscopy (SEM) analysis on the cross section of the strands from both examples showed that the strands were of essentially uniform cell morphology throughout.

### Example 6

A foamed strand 4-8 mm in diameter is produced from the polymer mixture Ultem™ 1000 PEI/RADEL® R-5100 NT polyphenylsulfone in a 65/35 ratio according to the general procedure, as described above. The mixture obtained in the B extruder is cooled down to a temperature of about 220-240° C. Scanning electron microscopy (SEM) analysis on the cross section of the strands from both examples showed that the strands are of essentially uniform cell morphology throughout.

### Comparative Example 7

A foamed strand 4-8 mm in diameter is produced from the polymer mixture Ultem™ 1000 PEI/Veradel® A-201 NT polyethersulfone in a 50/50 ratio according to the general procedure, as described above. The mixture obtained in the B extruder is cooled down to a temperature of about 220-240° C. The foam strand is not of a uniform appearance across the cross section of the strand. Controlling the uniform cross sectional diameter for the strands is also more difficult than in the case of Examples 5 and 6. SEM analysis of the foam strands showed the cell size and cell density to vary greatly between the center of the strand and the exterior. This makes it difficult to use these foams as structural materials because the mechanical properties, which depend on uniformity of cell size and structure, would not be uniform throughout the foam.

### Comparative Example 8

A foamed strand 4-8 mm in diameter is produced from the polymer mixture Ultem™ 1000 PEI/Udel® P-1700 NT polysulfone in a 50/50 ratio according to the general procedure, as described above. The mixture obtained in the B extruder is cooled down to a temperature of about 220-240° C. The foam strand is not of a uniform appearance across the cross section of the strand. Controlling the uniform cross sectional diameter for the strands is also more difficult than in the case of Examples 5 and 6. SEM analysis of the foam strands showed the cell size and cell density to vary greatly between the center of the strand and the exterior. This makes it difficult to use these foams as structural materials because the mechanical properties, which depend on uniformity of cell size and structure, would not be uniform throughout the foam.

(II) General Procedure for the Preparation of Material for Foaming a Second Set of Examples

A polymer or polymer mixture was compounded with 1.5 parts of TiO₂ per hundred parts of resin. Compounding into pellets was performed on a Berstorff 25 mm twin screw extruder having an L/D ratio of 40:1 and eight barrel sections, of which sections 2-8 were equipped with heating and cooling. In each case, the base polymer pellets and the TiO₂ were first tumble-blended for twenty minutes and then the mix was fed to the throat of the extruder. The extruder was set at a barrel temperature of 330° for barrel sections 2-8. The die temperature was set at 340° C. and a screw speed of 200 rpm was used along with a throughput rate of 25 lb/hr for each of the four formulations. Vacuum venting of the melt was performed at barrel section 7. The extrudate from the extruder in each case was cooled in a water trough and then pelletized. The pellets produced from the formulation were dried at temperatures between 130 and 180° C. for 8 hours and were next fed to the foaming set up which consisted of a 41 mm diameter Reifenhauser twin screw extruder set in series with a 50 mm Reifenhauser single screw extruder. The first extruder (A extruder) output was fed via a melt pipe directly into the second (B extruder) in a parallel configuration. The A extruder had an L/D ratio of 43 while the B extruder had an L/D of 30. The B extruder was equipped with a 1 mm slit die. The pellets produced from the formulation were fed to the A extruder where they melted. The injection point for the blowing agent was located at two thirds of the way down the axial length of the A extruder. Isopropanol was metered and injected into the polymer melt at pressures of 60-150 bar depending on the present melt pressure in the extruder. The homogenized polymer melt and isopropanol mixture were then fed into the B extruder where the mixture was cooled down to temperatures between 220 and 280°. The mixture was then extruded through the slit die and into a calibrator to form a foamed sheet.

### Example 9

Using the general procedure (II) described above, a foamed sheet was produced from the polymer mixture Ultem™ 1000 PEI/RADEL® R-5100 NT polyphenylsulfone in a 75/25 ratio by weight.

The resulting foam was found to have a density of 55±0.3 kg/m³, and from SEM analysis, a highly uniform cell morphology with a cell size of 103±15 microns in the machine direction, and 99±11 microns in the transverse direction.

### Example 10

Using the general procedure (II) described above, a foamed sheet was produced from the polymer mixture Ultem™ 1000 PEI/RADEL® R-5100 NT polyphenylsulfone in a 50/50 ratio by weight.

The resulting foam was found to have a density of 37±0.5 kg/m³, and from SEM analysis, a highly uniform cell morphology with a cell size of 242±46 microns in the machine direction, and 284±43 microns in the transverse direction.

### Example 11

A foamed sheet was produced from the polymer mixture Ultem™ 1000 PEI/RADEL® R-5100 NT polyphenylsulfone in a 25/75 ratio by weight according to the general procedure (II), described above.

The resulting foam was found to have a density of 38±0.3 kg/m³, and from SEM analysis, a highly uniform cell morphology with a cell size of 256±52 microns in the machine direction, and 284±43 microns in the transverse direction.

### Comparative Example 12

Using the general procedure (II) described above, a foamed sheet was produced from 100° A by weight of the polymer resin RADEL® R-5100 NT polyphenylsulfone.

The resulting foam was found to have a density of 40±0.8 kg/m³, and from SEM analysis, an uniform cell morphology with a cell size of 339±71 microns in the machine direction, and 400±77 microns in the transverse direction.

### Comparative Example 13

A foamed sheet was produced from 100% by weight polymer resin Ultem™ 1000 PEI according to the general procedure (II), described above.

The resulting foam was found to have a density of 63.8±2.5 kg/m³, and from SEM analysis, an uniform cell morphology with a cell size of 47.2±5.6 microns in the machine direction, and 61.8±9.0 microns in the transverse direction.

(III) Mechanical Properties of the Foam Sheets of Examples 9-11 and Comparative Examples 12-13.

The compressive strength (MPa) has been measured according to the ASTM D1621 method and the results are summarized in Table 1.

Said compressive strength values (MPa) were normalized with respect to a density value of 40 kg/m³. Thus, the normalized compressive strength (MPa) was calculated according to following equation, below:

$${CS}_{N} = \frac{{CS}_{dx}}{{( \frac{dx}{40.0} )}^{1.5}}$$

CS_{N}=normalized compressive strength expressed in MPa.
dx=density value in kg/m³
CS_{dx}=compressive strength (MPa) at give density value of x kg/m³

TABLE 1

| | dx^{(a)} | CS_{dx}^{(b)} | CS_{N} |
|---|---|---|---|
| Example 9 | 55 ± 0.3 | 0.77 ± 0.04 | 0.48 ± 0.03 |
| Example 10 | 37 ± 0.5 | 0.39 ± 0.01 | 0.44 ± 0.01 |
| Example 11 | 38 ± 0.3 | 0.43 ± 0.01 | 0.45 ± 0.01 |
| Comparative | 40 ± 0.8 | 0.31 ± 0.01 | 0.31 ± 0.01 |
| Example13 | | | |
| Comparative | 64 ± 2.5 | 0.66 ± 0.09 | 0.32 ± 0.03 |
| Example 14 | | | |

^{(a)}measured according to ASTM D1622
^{(b)}measured according to ASTM D1621.

1. A foam material made from a composition (C) comprising a polyetherimide (PEI) and a poly(biphenyl ether sulfone) (P2) wherein said composition (C) comprises more than 85 wt. % of the polyetherimide and the poly(biphenyl ether sulfone) (P2), based on the total weight of the composition (C), with the proviso that the polyetherimide and the poly(biphenyl ether sulfone) (P2) are the only polymeric components in the composition (C).

2. The foam material according to claim 1, wherein the weight of the polyetherimide, based on the total weight of the polyetherimide and the poly(biphenyl ether sulfone), is above 10%.

3. The foam material according to claim 1, wherein the weight of the polyetherimide, based on the total weight of the polyetherimide and the polyphenylsulfone (P2), is below 90%.

4. The foam material according to claim 1, wherein more than 50% of recurring units (R1) in the polyetherimide are recurring units (R1a) selected from the group consisting of imides of formula (XXV), amic acids of formula (XXVI), amic acids of formula (XXVII), and mixtures thereof: 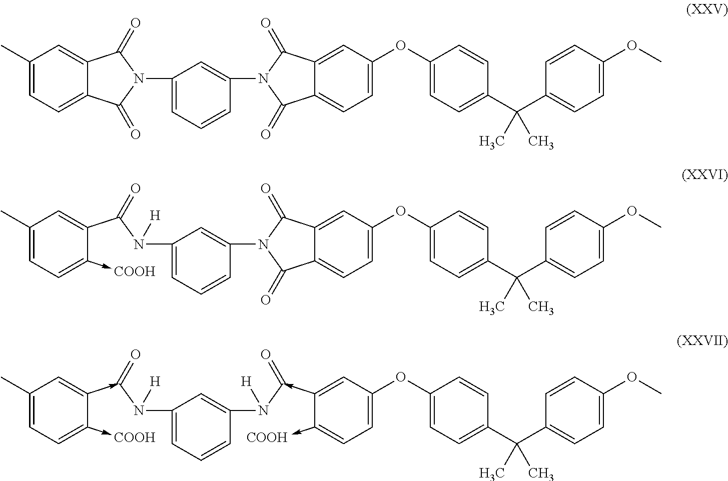
wherein in formulae (XXVI) and (XXVII) the → denotes isomerism so that in any recurring unit the groups to which the arrows point may exist as shown or in an interchanged position.

5. The foam material according to claim 1, wherein more than 50% of recurring units (R1) in the polyetherimide are recurring units (R1a-4) selected from the group consisting of imides of formula (XXVIII), amic acids of formula (XXIX), amic acids of formula (XXX), and mixtures thereof: 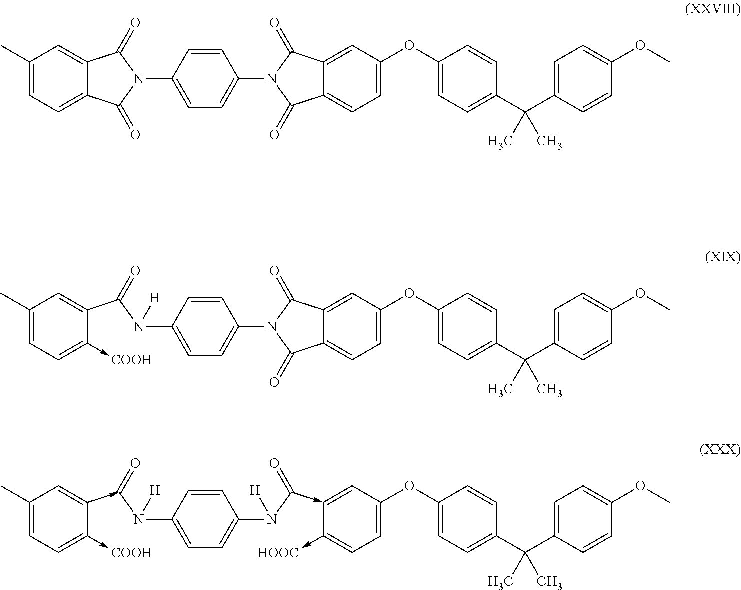
wherein in formulae (XXIX) and (XXX) the → denotes isomerism so that in any recurring unit the groups to which the arrows point may exist as shown or in an interchanged position.

6. The foam material according to claim 1, wherein the poly(biphenyl ether sulfone) (P2) is a polyphenylsulfone.

7. The foam material according to claim 1, wherein the foam material has a density of 20 to 250 kg/m³.

8. The foam material according to claim 1, wherein the foam material has a substantially uniform cell size.

9. A process for the manufacture of the foam material according to claim 1, wherein the process comprises foaming the composition (C) via a foaming process selected from the group consisting of a pressure cell processes, an autoclave processes and an extrusion processes.

10. The process according to claim 9, wherein the composition (C) further comprises a blowing agent in an amount from 1 to 15% by weight based on the total weight of the composition (C).

11. The process according to claim 9, wherein the composition (C) further comprises a nucleating agent in an amount from 0.1 to 5.0% by weight based on the total weight of the composition (C).

12. The process according to claim 9, wherein the foaming process is a physical foaming process.

13. An article comprising at least one component comprising the foam material according to claim 1.

14. The article of claim 13 wherein said article is a structural or secondary aircraft component.

15. The process according to claim 12, wherein the physical foaming process is an extrusion process.

16. A foam material made from a composition (C) comprising:
a polyetherimide comprising greater than 50% recurring units selected from the group consisting of imides of formula (XXVIII), amic acids of formula (XXIX), amic acids of formula (XXX), and mixtures thereof: 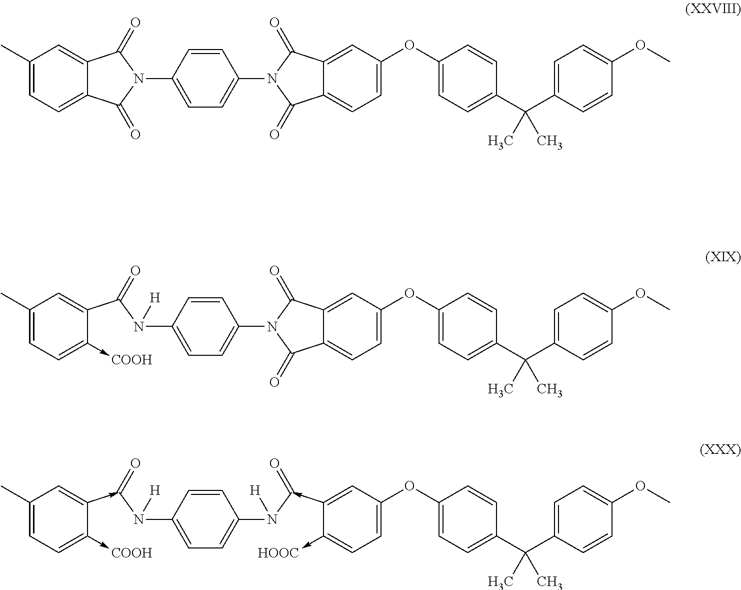
wherein the → denotes isomerism so that in any recurring unit the groups to which the arrows point may exist as shown or in an interchanged position,
a poly(biphenyl ether sulfone), and
a nucleating agent;
wherein the weight of the polyetherimide, based on the total weight of the polyetherimide and the poly(biphenyl ether sulfone), greater than 20% and less than 80%; and
wherein the polyetherimide and the poly(biphenyl ether sulfone) are present in a combined amount of greater than 85 wt. % of the total weight of the composition (C) and the nucleating agent is present in an amount of between 0.1 and 5.0 wt. % of the total weight of the composition (C),
with the proviso that the polyetherimide and the poly(biphenyl ether sulfone) are the only polymeric components in the composition (C).

17. A process for the manufacture of the foam material according to claim 16, wherein the process comprises foaming the composition (C) via a foaming process selected from the group consisting of a pressure cell processes, an autoclave processes and an extrusion processes.

18. An article comprising at least one component comprising the foam material according to claim 16.
